(19) United States
(12) Patent Application Publication
(10) Pub. No.: US 2015/0004084 A1
(43) Pub. Date: Jan. 1, 2015

(54) Methods and Systems for Capturing and Storing Carbon Dioxide

(71) Applicant: David S. Goldberg, New York, NY (US)

(72) Inventor: David S. Goldberg, New York, NY (US)

(21) Appl. No.: 14/370,512

(22) PCT Filed: Jan. 4, 2013
(86) PCT No.: PCT/US13/20186

§ 371 Date: Jul. 3, 2014

Related U.S. Application Data
(60) Provisional application No. 61/583,767, filed on Jan. 6, 2012.

(51) Int. Cl. B01D 53/62

(52) U.S. Cl. CPC B01D 53/62
USPC 423/226; 422/122

(57) ABSTRACT

Methods and systems for capturing and storing atmospheric carbon dioxide are disclosed. In some embodiments, the methods systems include the following: capturing carbon dioxide from atmospheric air using a reusable filter device; collecting and storing carbon dioxide captured by the filter device in a sub-ocean reservoir; regenerating the reusable filter device, which includes collecting the carbon dioxide captured by the reusable filter device; and generating a renewable energy using a renewable energy source for use in the method. The reusable filter device, the renewable energy source, and the sub-ocean reservoir are substantially co-located.

### CROSS REFERENCE TO RELATED APPLICATION(S)

This application claims the benefit of U.S. Provisional Application No. 61/583,767, filed Jan. 6, 2012, which is incorporated by reference as if disclosed herein in its entirety.

### BACKGROUND

Current carbon capture and storage (CCS) techniques focus on capture from large point sources. According to the Intergovernmental Panel on Climate Change (IPCC) report, about 60 percent of global carbon dioxide emissions from fossil-fuels are attributed to large stationary sources. Assuming 90 percent capture efficiency and 90 percent coverage of all sources, about 50 percent of global emissions would still be released into the atmosphere. This is far too much to allow for the stabilization of the atmospheric concentration of carbon dioxide and insufficient to constrain the growth of atmospheric carbon dioxide concentrations as the world economy grows.

Strategies for stabilizing atmospheric greenhouse gas concentrations will need to consider future CO₂ emissions from an enormous resource of worldwide fossil fuel supplies and a diverse range of mitigation technologies. The world currently emits ˜30 Gt CO₂/yr. If all potential resources of conventional fossil fuels, e.g., oil, gas, and coal, were used, total atmospheric emissions may exceed 5,500 Gt CO₂ or 1,500 Gt C. Exploitation of unconventional fossil fuels (tar sands, methane hydrates) and new extraction technologies could double this amount. Even if all emissions from large fixed sources could be captured, roughly 50% of global emissions would still be released into the atmosphere. The likelihood is that fossil fuel emissions will increase for decades, and thus, not allow for stabilization of atmospheric CO₂ below current levels of ˜400 ppm.

### SUMMARY

Aspects of the disclosed subject matter include methods and systems for capturing and storing carbon dioxide. More particularly, aspects of the disclosed subject matter include methods and systems that combine technologies for capturing carbon dioxide from atmospheric air and storing the captured carbon dioxide in co-located offshore storage reservoirs. Energy requirements of the methods and systems are at least partially supplied by carbon neutral/weather driven, i.e., wind, renewable energy.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter;

FIG. 2 is a schematic diagram of methods and systems according to some embodiments of the disclosed subject matter; and

FIG. 3 is a chart of a method according to some embodiments of the disclosed subject matter.

### DETAILED DESCRIPTION

Aspects of the disclosed subject matter include methods and systems for capturing and storing carbon dioxide. Some embodiments include the use of a reusable filter device for capturing carbon dioxide from air. The captured carbon dioxide is permanently stored in a sub-ocean reservoir. Energy for use in the system is generated using a renewable energy source such as a windmill. The reusable filter device, reservoir, and renewable energy source are all geographically co-located.

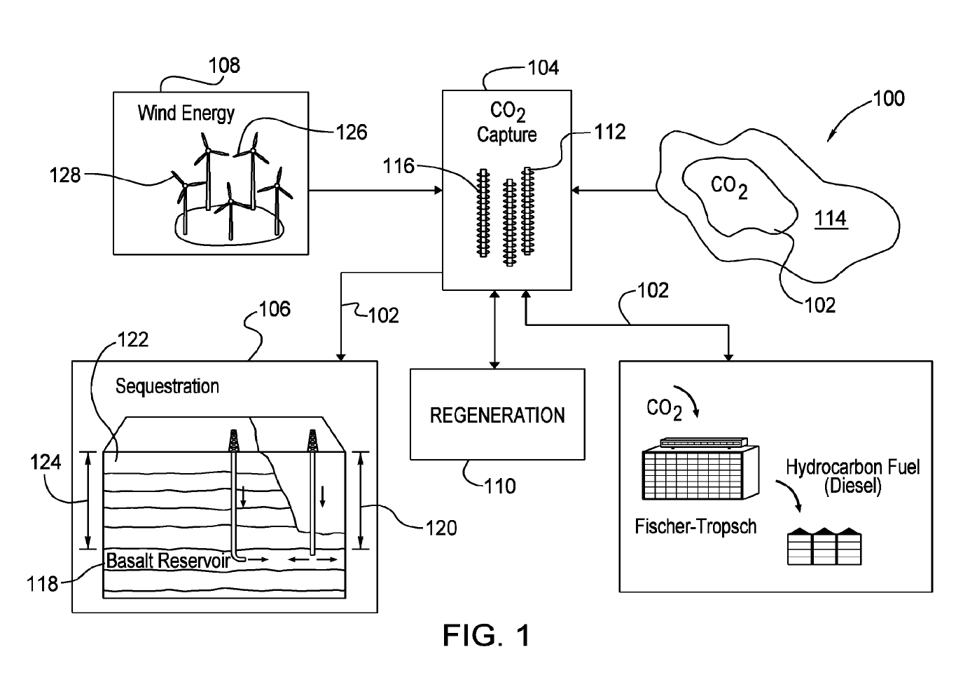

Referring now to FIG. 1, some embodiments include a system 100 for capturing and storing atmospheric carbon dioxide 102. System 100 includes a collection module 104, a storage module 106, an energy module 108, and a regeneration module 110, all of which are geographically co-located and interact with one another. In some embodiments, system 100 is substantially operated at room temperature.

Collection module 104 includes a reusable filter device 112 for capturing carbon dioxide 102 from atmospheric air 114. In some embodiments, reusable filter device 112 includes a moisture swing sorbent 116 such as one disclosed in International Patent Application No. PCT/US2012/051717, which is incorporated by reference as if disclosed herein in its entirety. Although discussed in detail below, as one skilled in the art will appreciate, methods and systems according to the disclosed subject matter are not limited to those including moisture swing sorbents. Other types of filter devices capable of capturing carbon dioxide from air while and having low energy requirements are contemplated.

Direct capture of CO₂ from ambient air has been developed as an energetically and economically viable climate mitigation technology. Air capture is akin to flue gas scrubbing in power plants, but because of the low concentration of CO₂ in air, sorbents for air capture must be stronger than those for flue gases. Several approaches for CO₂ capture have been proposed. Of these, the moisture swing approach, which is disclosed in International Patent Application No. PCT/US2012/051717, has particularly low energy consumption. In this process, the evaporative drying of water from a solid sorbent material provides the energy to drive the cycle.

In some embodiments, a resin-based sorbent composed of a polystyrene backbone with quaternary ammonium ligands attached to the polymer. The quaternary amine groups carry a permanent positive charge balanced by exchangeable Cl⁻ anions that for CO₂ sorption are replaced by hydroxide or carbonate ions. In the carbonate form, the resin captures CO₂ with the low binding energy of the carbonate to bicarbonate reaction but with a reaction kinetics faster than that of sodium hydroxide solutions. This process is governed by the reaction:

CO₃²⁻+CO₂+H₂O [symbol] 2HCO₃—.

It has been shown that for solid-resin sorbents of this type, the Langmuir isotherm equation describes the CO₂ loading as function of the partial pressure of CO₂. The isotherm shifts to much higher CO₂ pressures in the presence of water, and therefore, CO₂ loading of the resin strongly depends on the partial pressure of H₂O in air. Thus, a process cycle with CO₂ loaded onto dry resin and then driven off by moisture is created. Once dried, the resin is able to absorb CO₂ again.

Storage module 106 includes a sub-ocean reservoir 118 for collecting and storing carbon dioxide 102 captured by reusable filter device 112. In some embodiments, sub-ocean reservoir 118 is selected so that a water depth 120 above the sub-ocean reservoir is about 600 m to about 3000 m and the sub-ocean reservoir is covered by a sediment 122 having a thickness 124 of about 200 m or greater.

The effectiveness of geological CO₂ sequestration depends on a reservoir's storage capacity, stability, and risk for leakage. Recent studies identify igneous rocks as promising sequestration targets. Large igneous provinces (LIPs) are massive emplacements of intrusive and extrusive rocks that can extend hundreds of kilometers from their volcanic sources and occur all over the globe. When LIPs are extruded subaerially, they cool rapidly, forming porous outer rinds with large voids spaces. High porosity has been measured over thick flow sequences on land, such as Columbia River Plateau, Deccan Traps, and CAMP basalts. It is anticipated that CO₂ injected in basalt rocks would ultimately be sequestered in the form of thermodynamically stable and environmentally benign minerals. Basalt acts as a natural, in situ weathering reactor both on land and below the seafloor. Buried over time by impermeable marine sediments, submarine LIPs are further sealed while such chemical weathering proceeds.

In some embodiments, sub-ocean reservoirs are used that meet the following criteria: (1) the presence of a basalt flow with enhanced porosity (reservoir); (2) sediment thickness of greater than 200 m or more covering sub-seafloor basalt; and (3) water depths between 600 m and 3000 m. These criteria assure the physical trapping of injected CO₂ and allow for estimation of the total reservoir capacity. The overlying sediment acts as an impermeable cap to isolate reservoirs from potential upward leakage of injected CO₂. The 600-m minimum water depth ensures sufficient hydrostatic pressure of ocean and sediments to support CO₂ injection in supercritical state. The 3000-m maximum depth meets the practical limit of deep-water drilling technology.

Energy module 108 includes a renewable energy source 126 for generating a renewable energy, e.g., electricity, for use in method 100. In some embodiments, renewable energy source 126 is a windmill 128. Of course, some embodiments include other renewable energy sources, e.g., hydro-electric turbines, etc.

Regeneration module 110 includes mechanisms, e.g., regeneration processes, etc., for regenerating reusable filter device 112. In some embodiments, CO₂ capture from air is achieved using passive collectors that stand in the wind and take advantage of the high air flow for drying wet resin and for letting its CO₂ load equilibrate with ambient conditions. Again, referring to regeneration processes disclosed in International Patent Application No. PCT/US2012/051717, in order to achieve a significant saturation swing and at the same time maintain a substantial CO₂ pressure over the resin during unloading, a hybrid thermal/moisture swing process where moist air is the sweep gas that carries CO₂ away is used. Heat is required to raise the temperature of the resin to about 45° C. and simultaneously expose it to liquid water. The sweep gas carrying CO₂ is subsequently cooled to condense out water, and further cooled until CO₂ precipitates as dry ice. With warming, the CO₂ converts to a pressurized liquid. Heat exchange between cooling and warming streams provides a large part of the necessary heat transfer, and electrically driven heat pumps make up any short falls.

In some embodiments, the partial pressure over the wet loaded resin at about 45° C. is about 2 kPa, and a saturation swing from about 0.8 to 0.5 at this temperature reduces the partial pressure below 0.5 kPa. Using the hybrid swing process to return the resin to ambient temperature, a significant fraction of the resin capacity is regenerated.

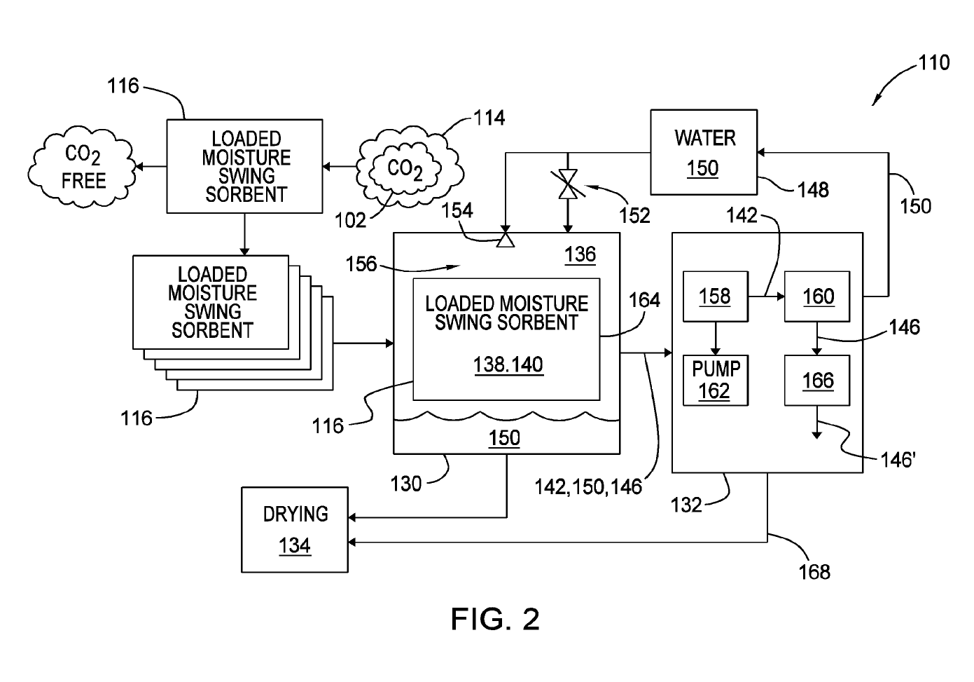

Referring now to FIG. 2, which includes regeneration processes disclosed in International Patent Application No. PCT/US2012/051717, in some embodiments, regeneration module 110 includes a includes a wetting module 130, a carbon dioxide collection module 132, and a drying chamber 134, all of which are in fluid communication with one another.

Wetting module 130 includes a wetting chamber 136 for wetting moisture swing sorbent 116, which is substantially dry and loaded with bicarbonate 138. Bicarbonate 138 is substantially formed with carbon dioxide 102 captured from air 114. Moisture swing sorbent 116 is typically wetted until bicarbonate 138 in the sorbent decomposes to carbonate 140 and a stream 142 including water 144 and carbon dioxide gas 146. Carbon dioxide gas 146 is substantially released from moisture swing sorbent 116. Wetting module 130 includes a supply 148 of water 150 in fluid connection with wetting chamber 136. In some embodiments, wetting module 130 includes a filling mechanism 152, e.g., a conduit and valve, to fill wetting chamber 136 with water 150. In some embodiments, wetting module 130 includes a spray mechanism 154 for spraying droplets 156 of water 150 on moisture swing sorbent 116, which is positioned in wetting chamber 136.

Carbon dioxide collection module 132 includes a vacuum chamber 158, a condenser 160 for removing water 150 from stream 142, a pump 162 for creating a vacuum on a side 164 of moisture swing sorbent 116 to pull carbon dioxide gas 146 released from the moisture swing sorbent out of wetting chamber 136, and a compressor 166 for compressing the carbon dioxide gas into a liquid form 146′. In some embodiments, vacuum chamber 158 does not cover all of moisture swing sorbent 116, e.g., it has a bubble-shaped cover (not shown) that only covers portions of the sorbent thus avoiding the need for a full vacuum chamber.

Drying chamber 134 dries moisture swing sorbent 116, which is substantially free of carbon dioxide 102 and bicarbonate 138. In some embodiments, spin drying is used to increase the amount of water 150 recovered from moisture swing sorbent 116. In some embodiments, a heat 168 generated by condenser 160 and compressor 166 is used to dry moisture swing sorbent 116.

In some embodiments, the carbon dioxide released from the sorbent is re-dissolved into a solvent on the other side of the sorbent, e.g., re-dissolved into a sodium carbonate solution for capture and quantification of amount captured. In some embodiments, a sweep gas that flows through the sorbent is used to capture and collect the carbon dioxide released from the sorbent. In some embodiments, a counter-stream design is used, i.e., carbon dioxide and water vapor are transferred from nearly depleted and heated sorbent to partially loaded sorbent and fully loaded sorbent, which leaves the sorbent more depleted and less wet. The carbon dioxide concentration increases until it exits from end of the freshest sorbent.

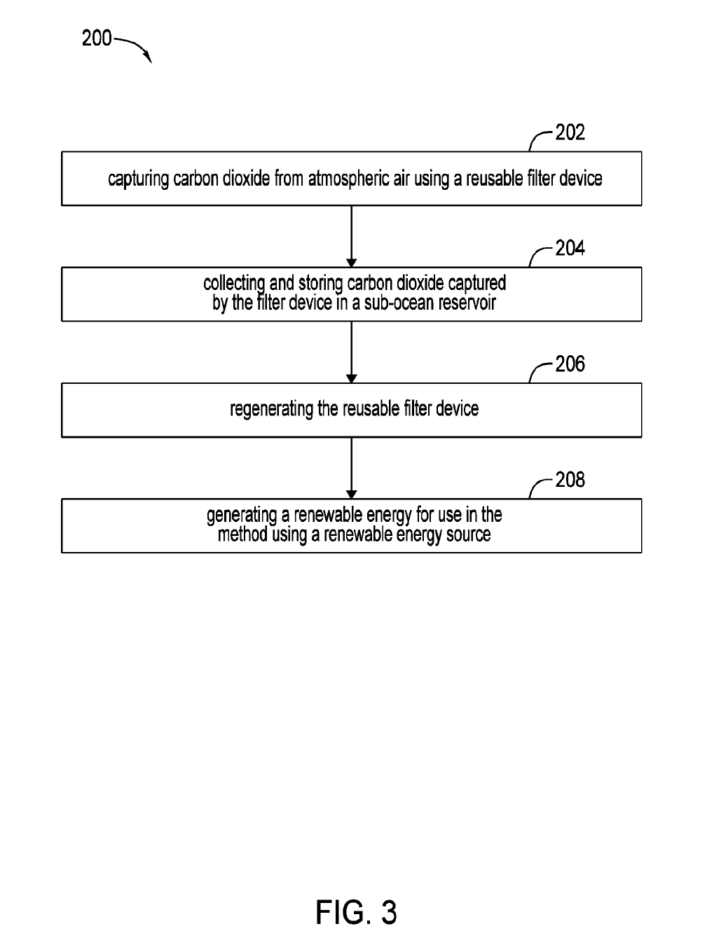

Referring now to FIG. 3, some embodiments include a method 200 for capturing and storing atmospheric carbon dioxide. At 202, carbon dioxide is captured from atmospheric air using a reusable filter device. In some, but not all embodiments, the reusable filter device includes a moisture swing sorbent such as those disclosed in International Patent Application No. PCT/US2012/051717 for carbon dioxide capture. In some embodiments, the moisture swing sorbent includes an ion-exchange material that is a co-extruded sheet having a polymer matrix and a resin powder having quaternary ammonium functional groups. At 204, carbon dioxide captured by the filter device is collected and stored in a sub-ocean reservoir. At 206, the reusable filter device is regenerated. In some embodiments, the reusable filter device is regenerated by performing the following steps: (1) providing a moisture swing sorbent that is substantially dry and loaded with bicarbonate substantially formed with carbon dioxide captured from air; (2) wetting the moisture swing sorbent until the bicarbonate in the sorbent decomposes to carbonate and a stream including water and carbon dioxide gas, wherein the carbon dioxide gas is substantially released from the sorbent; (3) condensing the stream to remove water from the stream; (4) collecting the carbon dioxide gas; and (5) drying the moisture swing sorbent until it is substantially dry. At 208, a renewable energy, e.g., electricity, is generated using a renewable energy source. The renewable energy is used in method 200. In some embodiments, the renewable energy source is a windmill. In order to enhance the efficiency of method 200, in some embodiments, the reusable filter device, the renewable energy source, and the sub-ocean reservoir are substantially co-located.

Methods and systems according to the disclosed subject matter offer benefits over known technology. With the combined use of wind resources, CO₂ air capture, sequestration, and remote synfuel production, methods and systems according to the disclosed subject matter function as an energetically self-sustainable carbon collection point. In combination with air capture, some embodiments offer energy production estimated at 47 TWh using 3000 on-shore/near-shore wind turbines, which can be converted annually into approximately 770 million gallons of diesel using about 8 Mt of collected CO₂. These estimates amount to only 10% utilization of the installed air capture capacity, assuming all wind energy is used for fuel production. The proportion of energy used for CO₂ collection and sequestration versus fuel production can be scaled to balance the infrastructural needs and fuel/carbon price economics on the short term. Over the long term, wind resources can be increased to allow for greater energy production or a different product balance.

Numerous studies have explored the technical options, risks, and public issues involved with geological CO₂ sequestration. Specifically, risks associated with 1) leakage, 2) groundwater safety, 3) land access, 4) storage permanence, and 5) long-term liability remain outstanding issues of major concern for on land CO₂ sequestration. In methods and systems according to the disclosed subject matter, the use of sub-ocean reservoirs offers permanent and safe sequestration, minimal environmental risks from leakage, distance from populated areas, and negligible expected damages, all of which provide long-term risk benefits. Offshore sequestration mitigates risk of damages from induced earthquakes and concerns of harm from produced/expelled fluids for potable aquifers after CO₂ injection. Because sub-seafloor reservoirs are laterally extensive reservoirs, saturated with seawater, and capped by impermeable sediments, the consequences of small pressure increases are unlikely to cause faulting and seawater displaced by CO₂ injection will be benign in the ocean.

The potential benefits of long-term carbon management using sub-ocean reservoirs are large. Using locations with carbon-neutral energy sources and in close proximity to large and secure reservoirs for geological sequestration of captured CO₂ offers many benefits. While mobilizing the industrial infrastructure in remote areas may be costly, it can ultimately provide sufficient air capture and sequestration capacity for the reduction of atmospheric carbon to preindustrial levels.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method for capturing and storing atmospheric carbon dioxide, said method comprising:
capturing carbon dioxide from atmospheric air using a reusable filter device;
collecting and storing carbon dioxide captured by said filter device in a sub-ocean reservoir;
regenerating said reusable filter device; and
generating a renewable energy using a renewable energy source, said renewable energy being used in said method;
wherein said reusable filter device, said renewable energy source, and said sub-ocean reservoir are substantially co-located.

2. The method according to claim 1, wherein said renewable energy source is a windmill.

3. The method according to claim 1, wherein said reusable filter device includes a moisture swing sorbent for carbon dioxide capture.

4. The method according to claim 3, wherein said moisture swing sorbent includes an ion-exchange material.

5. The method according to claim 4, wherein said material is a co-extruded sheet that includes a polymer matrix and a resin powder having quaternary ammonium functional groups.

6. The method according to claim 3, wherein regenerating said reusable filter device further comprises:
providing a moisture swing sorbent that is substantially dry and loaded with bicarbonate substantially formed with carbon dioxide captured from air;
wetting said moisture swing sorbent until said bicarbonate in said sorbent decomposes to carbonate and a stream including water and carbon dioxide gas, wherein said carbon dioxide gas is substantially released from said sorbent;
condensing said stream to remove water from said stream;
collecting said carbon dioxide gas; and
drying said moisture swing sorbent until it is substantially dry.

7. A system for capturing and storing atmospheric carbon dioxide, said system comprising:
a collection module including a reusable filter device for capturing carbon dioxide from atmospheric air using a reusable filter device;
a storage module including a sub-ocean reservoir for collecting and storing carbon dioxide captured by said filter device;
an energy module including a renewable energy source for generating a renewable energy for use in said method; and
a regeneration module for regenerating said reusable filter device;
wherein said reusable filter device, said renewable energy source, and said sub-ocean reservoir are substantially co-located.

8. The system according to claim 1, wherein said renewable energy source is a windmill.

9. The system according to claim 8, wherein said system is substantially operated at room temperature.

10. The system according to claim 1, wherein said reusable filter device includes a moisture swing sorbent.

11. The system according to claim 8, wherein a water depth above said sub-ocean reservoir is about 600 m to about 3000 m.

12. The system according to claim 8, wherein said sub-ocean reservoir is covered by a sediment having a thickness of about 200 m or greater.

13. The system according to claim 10, wherein said regeneration module further comprises:
a wetting module including a wetting chamber for wetting a moisture swing sorbent that is substantially dry and loaded with bicarbonate substantially formed with carbon dioxide captured from air until said bicarbonate in said sorbent decomposes to carbonate and a stream including water and carbon dioxide gas, wherein said carbon dioxide gas is substantially released from said sorbent;
a carbon dioxide collection module for collecting said carbon dioxide gas released from said moisture swing sorbent and compressing it into a liquid form, said carbon dioxide collection module including a condenser for removing said water from said stream, a pump for creating a vacuum on a side of said moisture swing sorbent to pull said carbon dioxide gas released from said moisture swing sorbent out of said wetting chamber, and a compressor for compressing said carbon dioxide gas it into said liquid form; and
a drying chamber for drying said moisture swing sorbent that is substantially free of carbon dioxide and bicarbonate.

14. A method of capturing and storing atmospheric carbon dioxide, said method comprising:
capturing carbon dioxide from atmospheric air using a reusable filter device;
collecting and storing carbon dioxide captured by said moisture swing sorbent in a sub-ocean reservoir;
regenerating said reusable filter device; and
generating electrical energy using a renewable electrical energy source, said renewable electrical energy being used in said method;
wherein said reusable filter device, said renewable electrical energy source, and said sub-ocean reservoir are substantially co-located.

15. The method according to claim 14, wherein said renewable electrical energy source includes a windmill.

16. The method according to claim 14, wherein said reusable filter device includes a moisture swing sorbent having an ion-exchange material.

17. The method according to claim 16, wherein said material is a co-extruded sheet that includes a polymer matrix and a resin powder having quaternary ammonium functional groups.

18. The method according to claim 14, wherein a water depth above said sub-ocean reservoir is about 600 m to about 3000 m.

19. The method according to claim 14, wherein said sub-ocean reservoir is covered by a sediment having a thickness of about 200 m or greater.

20. The method according to claim 14, wherein regenerating said reusable filter device further comprises:
providing said moisture swing sorbent that is substantially dry and loaded with bicarbonate substantially formed with carbon dioxide captured from air;
wetting said moisture swing sorbent until said bicarbonate in said sorbent decomposes to carbonate and a stream including water and carbon dioxide gas, wherein said carbon dioxide gas is substantially released from said sorbent;
condensing said stream to remove water from said stream;
collecting said carbon dioxide gas; and
drying said moisture swing sorbent until it is substantially dry.
